(19) United States
(12) Patent Application Publication
(10) Pub. No.: US 2026/0131462 A1
(43) Pub. Date: May 14, 2026

(54) OVERLOAD ADAPTIVE ROBOTIC SYSTEM

(71) Applicant: Dexterity, Inc., Redwood City, CA (US)

(72) Inventor: Zhouwen Sun, San Mateo, CA (US)

(21) Appl. No.: 19/274,368

(22) Filed: Jul. 18, 2025

Related U.S. Application Data
(60) Provisional application No. 63/674,630, filed on Jul. 23, 2024.

(51) Int. Cl. B25J 9/16

(52) U.S. Cl. CPC B25J 9/1641

(57) ABSTRACT

An overload adaptive robotic system is disclosed. In various embodiments, the system includes a robotic arm comprising one or more links, one or more joints, and an end effector positioned at a distal free moving end of the robotic arm; and a processor configured to: make and begin to implement a plan to grasp an item, move the item through a planned trajectory, and place the item at a destination; detect an overload condition affecting a joint include in the one or more joints; and adapt the plan in response to detecting the overload condition.

### CROSS REFERENCE TO OTHER APPLICATIONS

This application claims priority to U.S. Provisional Ser. No. 63/674,630 entitled OVERLOAD ADAPTIVE ROBOTIC ARM filed Jul. 23, 2024 which is incorporated herein by reference for all purposes.

### BACKGROUND OF THE INVENTION

Robotic arms and other robots have been used to perform tasks in industrial settings. For example, in warehouses and other logistics settings, robots have been used to load and unload trucks and other containers; load and unload pallets, boxes, and other receptacles; perform sortation and/or singulation of items; etc.

A robotic arm may be used to handle items of diverse sizes, shapes, weights, materials, etc. In some contexts, arbitrary diverse items may be grasped, e.g., one by one, from a flow, pile, or other source and once grasped an item may be moved singly, while in the grasp of the robotic arm, to a destination. For example, the robotic arm may be moved through a sequence of poses, in and through three-dimensional space, to get from a starting pose and position at which an item is grasped to a destination pose and position at which the item is to be placed.

In some cases, attributes of an item may be determined and used to decide whether and how to grasp and move an item. For example, camera-generated images or other sensor data may be used to determine the location, shape, orientation, etc. of an item to be grasped, along with attributes such as its weight, rigidity, packaging characteristics, etc.

Some attributes of an item, such as its weight, may be considered in determining whether and how to grasp an item, and the poses the robot will maintain and/or be moved to or through to move the item through a trajectory.

Typically, a joint/link comprising a robotic arm is moved by controlling a motor that is coupled to the joint/link via a gearbox. The gearbox may be a planetary gearbox that is not “backdrivable”. A non-backdrivable gearbox is one that moves in only one direction, as driven by an associated motor, and which is not configured to be driven in the opposite direction, e.g., by a force/torque applied to the output shaft of the gearbox. An advantage of such a gearbox, in some typical robotics contexts, is that force/torque may not need to be applied continuously or to such a great extent to maintain a robotic arm and/or portion thereof in a desired pose, once the motor has been used to drive the gearbox and associated joint/link to the desired position.

A non-backdrivable gearbox and/or other associated components, such as the motor, may be damaged if an excessive load is applied to the output shaft of the gearbox, such as could occur if the robotic arm is used to grasp an item that is much heavier than the robotic system anticipated.

### BRIEF DESCRIPTION OF THE DRAWINGS

Various embodiments of the invention are disclosed in the following detailed description and the accompanying drawings.

FIGS. 1A through 1F illustrate an embodiment of a robotic arm and system that adapts to an overload.

FIGS. 2A through 2C illustrate examples of structures used in various embodiments to provide a robotic with overload adaptive behavior.

FIGS. 3A and 3B show an example of a clutch assembly to mechanically couple and/or decouple a load from a joint.

FIG. 4A illustrates an example of oscillation of a load with respect to a robotic arm joint in an underdamped condition.

FIG. 4B illustrates an example of oscillation of a load with respect to a robotic arm joint in an actively damped condition.

FIGS. 5A and 5B illustrate an example of a system incorporating a brake to gradually arrest movement of a load with respect to an overloaded joint.

FIG. 6 illustrates an embodiment of a robotic arm and system that adapts to an overload.

FIG. 7 is a flow chart illustrating an embodiment of a process to adapt to an overload.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic system that adapts gracefully to an overload condition is disclosed. In various embodiments, techniques disclosed herein are used to provide a wrist or other joint assembly that responds to an overload, e.g., grasped item is too heavy to be held in a planned pose, by giving way and allowing or actively causing the load to settle or swing into a position such that the wrist or other joint is not overloaded.

For example, in some embodiments, the wrist and/or associated components allow(s) an item that turns out to be too heavy for the wrist to hold in a planned pose to settle into an alternative pose in which the load is suspended directly below the wrist. The wrist may go “limp”, in a sense, and allow the item to be dangled below the wrist. In such a pose, the wrist must support the weight of the item hanging from it but does not have to supply the torque required to hold the item out at a non-zero angle from the vertical.

An overload condition may include a weight or torque that a joint is not able to support or sustain, an unexpected or otherwise problematic weight distribution (e.g., even distribution was expected and instead an end of a long or large object that is not near the end effector has more weight), unexpectedly low or high rigidity, unexpected packaging or packaging attributes, or a collision with an obstacle in the workspace, such as another robot, a wall or other fixed structure, another box or other item, another robot, or a link or other structure comprising the robot itself.

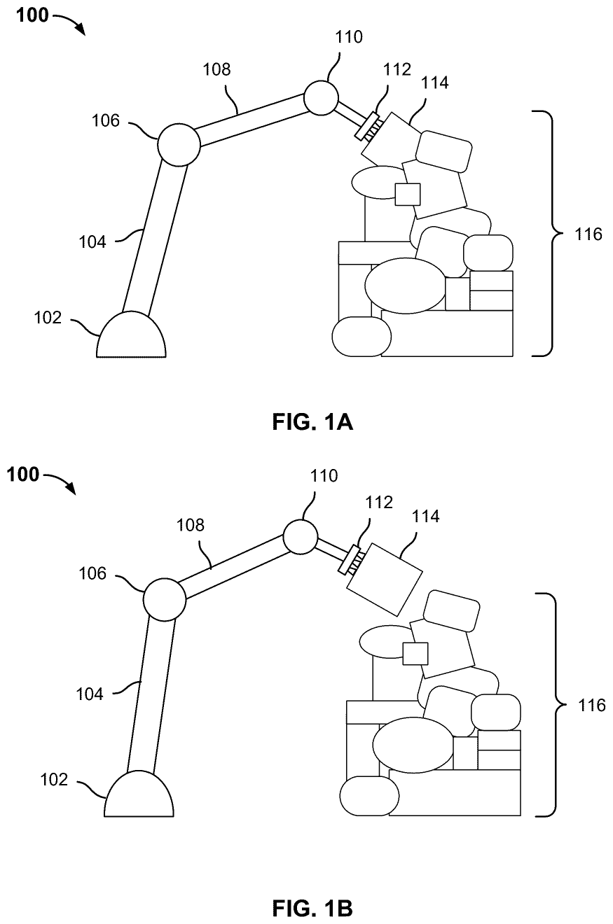

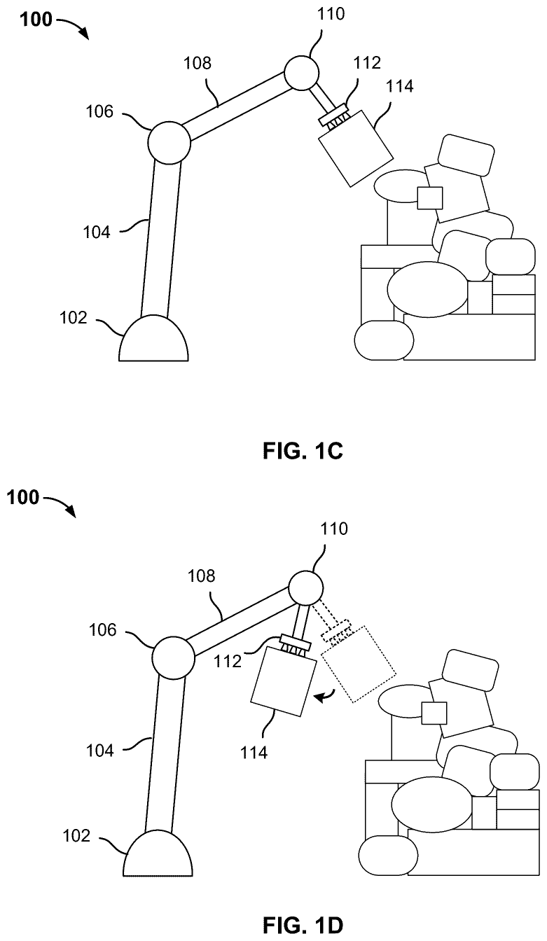

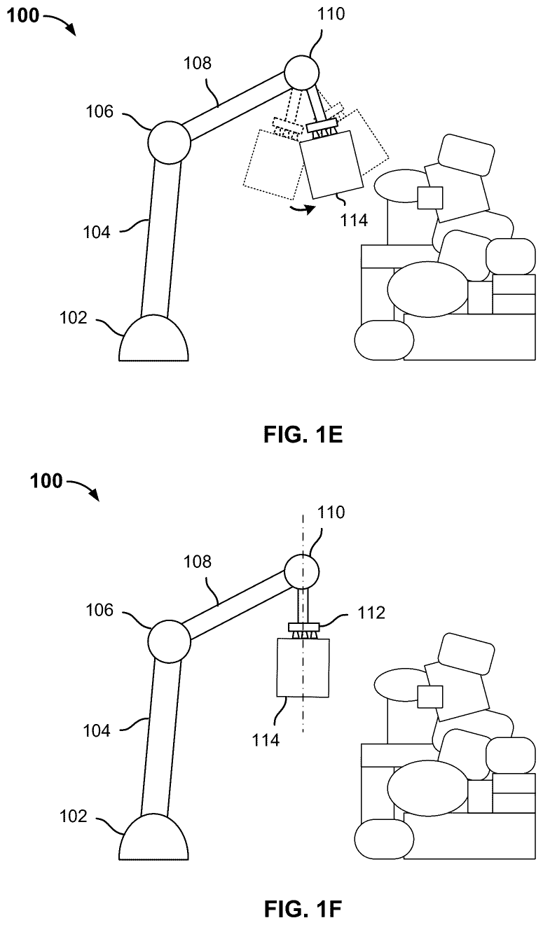

FIGS. 1A through 1F illustrate an embodiment of a robotic arm and system that adapts to an overload, in this example of the wrist joint. In the example shown, robot 100 includes a shoulder joint 102, upper arm link 104, elbow joint 106, forearm link 108, wrist joint 110 and (suction type) end effector 112.

In the state shown in FIG. 1A, robotic arm 100 has been positioned to use end effector 112 to grasp box 114 from a pile 116 of items of diverse shapes, sizes, weights, etc. As shown in FIG. 1B, shoulder joint 102 has been used to move the remaining joints/links—held in the same pose as in FIG. 1A, to pull and lift box 114 from pile 116.

Initially, as shown in FIG. 1A, some of the weight of box 114 would be supported by items on which it was resting in pile 116. However, as shown in FIGS. 1C, 1D, and 1E, in this example the weight of box 114 turned out to be heavier than anticipated, with the result that the wrist 110 could not safely continue to hold the box 114 in the pose as shown in FIGS. 1A and 1B, resulting in the wrist 110 becoming “limp”, in a sense, and allowing the box 114 to swing first to the left, as shown in FIG. 1D and then back to the right as shown in FIG. 1E, prior to settling in the vertical up-and-down position as shown in FIG. 1F.

In various embodiments, an adaptive behavior, as illustrated by FIGS. 1C through 1F, protects the wrist (e.g., gearbox and/or motor) from damage while maintaining a grasp on box 114.

In various embodiments, upon detecting that the adaptive behavior illustrated by FIGS. 1C through 1F resulted in the robotic arm 100 being in the pose as shown in FIG. 1F, the robotic system would plan a new trajectory to move the box 114 from pose and position as shown in FIG. 1F to the intended destination at which the box 114 is to be placed, including by planning a trajectory that allows the box 114 to be suspended directly below the wrist 110, as shown in FIG. 1F, as the robotic arm 100 moves through the trajectory. In some cases/embodiments, it may further be necessary to adjust one or more of the destination location and orientation at which the box 114 is to be placed, e.g., to one that would allow for the box 114 to be placed while held in a top down grasp, thereby allowing the box 114 to continue to be suspended below the wrist 110 through the entire trajectory and placement.

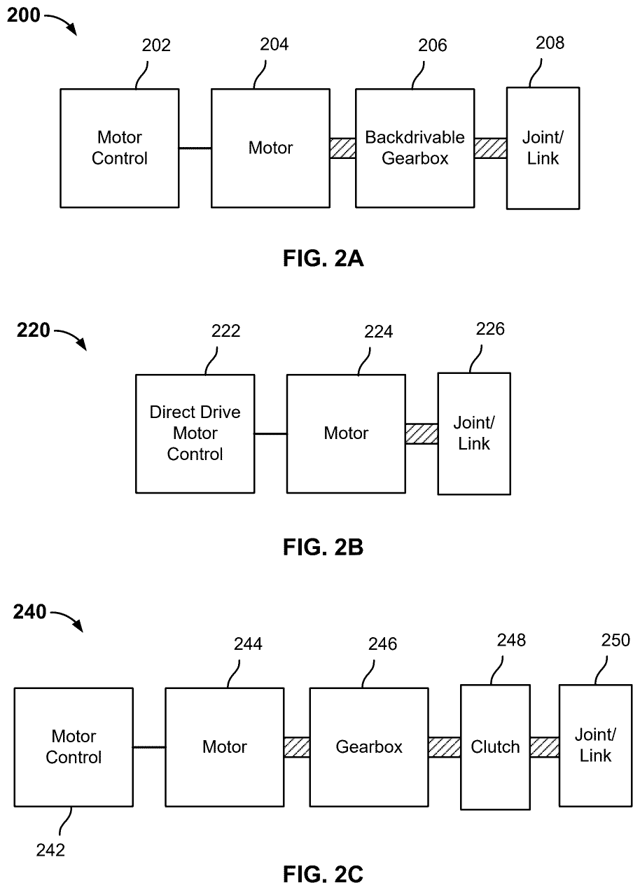

FIGS. 2A through 2C illustrate examples of structures used in various embodiments to enable/provide overload adaptive behavior, such as that illustrated and described above in connection with FIGS. 1A through 1F.

In the example shown in FIG. 2A, wrist (or other) joint subsystem 200 includes a motor control component 202 (e.g., one or more of a motor controller, a robot controller, and a remote control computer) configured to supply commands and/or current to a motor 204 the output torque of which is supplied via an motor output shaft to a backdrivable gearbox 206 coupled fixedly to a joint/link 208. In this example, the adaptive behavior shown in FIGS. 1A through 1F would be provided by the backdrivable gearbox 206 being driven in the direction that allows the load to move into the position beneath the wrist 110.

For example, in some embodiments, the weight of the grasped object may exert a force/torque greater than that applied by the motor 204, resulting in the backdrivable gearbox 206 allowing the load to swing down to a torque-neutral position, as in FIG. 1F. The robotic system may detect the overload condition and discontinue attempting to drive the motor 204 and gearbox 206 to maintain the originally planned pose. In some embodiments, the motor control 202 may supply commands and/or current to dampen oscillation of the load as the overloaded joint settles into the torque neutral pose, as in FIGS. 1C through 1F.

In the example shown in FIG. 2B, wrist (or other) joint subsystem 220 includes a direct drive motor control component 222 and a direct drive motor 224 coupled directly (i.e., not via a gearbox or other transmission mechanism) to the joint/link 226. A direct drive motor is inherently back drivable, since there is no gearbox between the motor output shaft and the load. In the example shown in FIGS. 1A through 1F, for example, the motor itself would rotate in the opposite direction, allowing the load to settle into the pose as shown in FIG. 1F.

In the example shown in FIG. 2C, wrist (or other) joint subsystem 240 includes a motor control component 242 configured to supply commands and/or current to a motor 244 the output torque of which is supplied via a motor output shaft to gearbox 246, which may not be back drivable. The output of gearbox 246 is coupled via a clutch assembly 248 to joint/link 250. In this example, the adaptive behavior shown in FIGS. 1A through 1F would be provided by the clutch assembly 248 being used to decouple the output of the gearbox 246 from the joint/link 250, allowing the wrist 110 to rotate/swing freely and the load to move into the position beneath the wrist 110.

For example, initially the excessive weight of the load may cause the clutch 248 to slip. The system may use computer vision and/or other sensors to detect the slippage and may release the clutch 248, allowing the load to swing and settle into a torque neutral position with respect to the overloaded joint, as in FIGS. 1C through 1F.

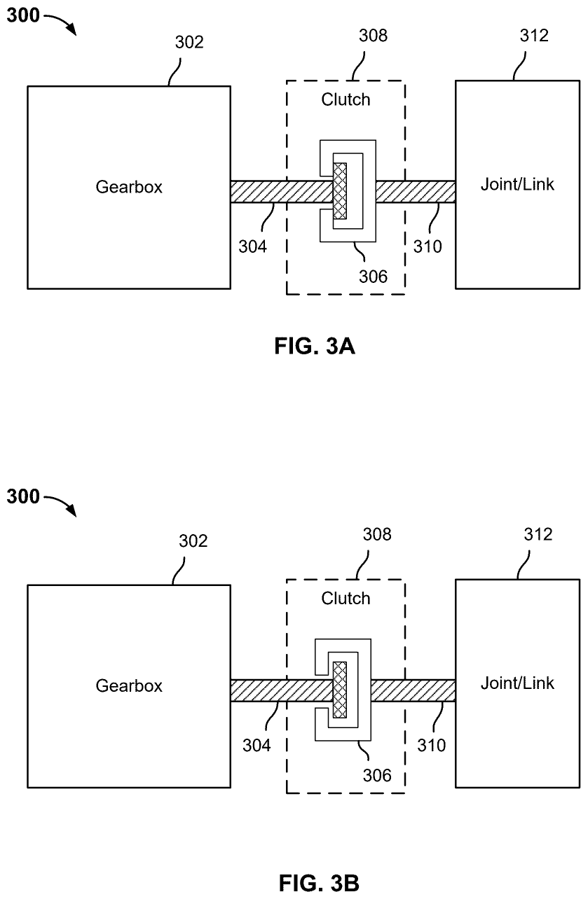

FIGS. 3A and 3B show an example of a clutch assembly, such as clutch assembly 248 of FIG. 2C. In the example shown, overload adaptive transmission assembly 300 includes a gearbox 302 that provides torque via an output shaft 304 that is coupled via a clutch 306 in clutch housing/assembly 308 to the joint/link 312 via shaft or other mechanical coupling or connection 310. In the state shown in FIG. 3A the clutch 306 is engaged, such that torque from the gearbox 302 is transmitted to the joint/link 312. In the state shown in FIG. 3B, clutch 306 has been disengaged, e.g., in response to detecting the overload condition, decoupling the joint/link 312 from the gearbox 302.

In some embodiments, a clutch mechanism as shown in FIGS. 3A and 3B may be used to react to a detected overload condition. For example, if a joint is observed (e.g., vision, torque, joint or motor position, or other sensors) to be experiencing an overload condition, the clutch may be disengaged as/if needed to protect the joint, gearbox, motor, or other equipment. In the case of a collision, the clutch may be disengaged to render the affected joint more compliant with external forces, reducing the risk of damage.

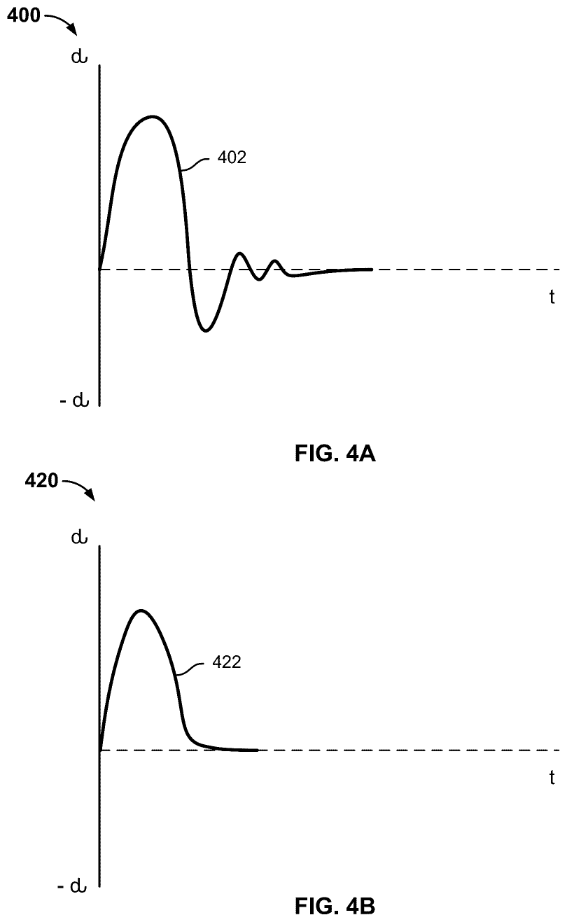

FIG. 4A illustrates the underdamped condition exhibited by an approach as illustrated in FIGS. 1A through 1F. In that example, box 114 swings from one side of the vertical to the other until it settles into the position as shown in FIG. 1F. However, in a real-world context, such swinging could result in box 114 being dropped, or bang into something in the workspace, or at a minimum a loss of time and/or precision. Therefore, in some embodiments, structures and techniques disclosed herein are used to achieve something closer to the more ideally/critically damped behavior as shown in FIG. 4B.

In some embodiments, the behavior shown in FIG. 4B is achieved by using a brake, such as a friction, disc, or other brake, to control and gradually arrest the movement of the grasped item, end effector, and wrist assembly as they settle into a pose as shown in FIG. 1F.

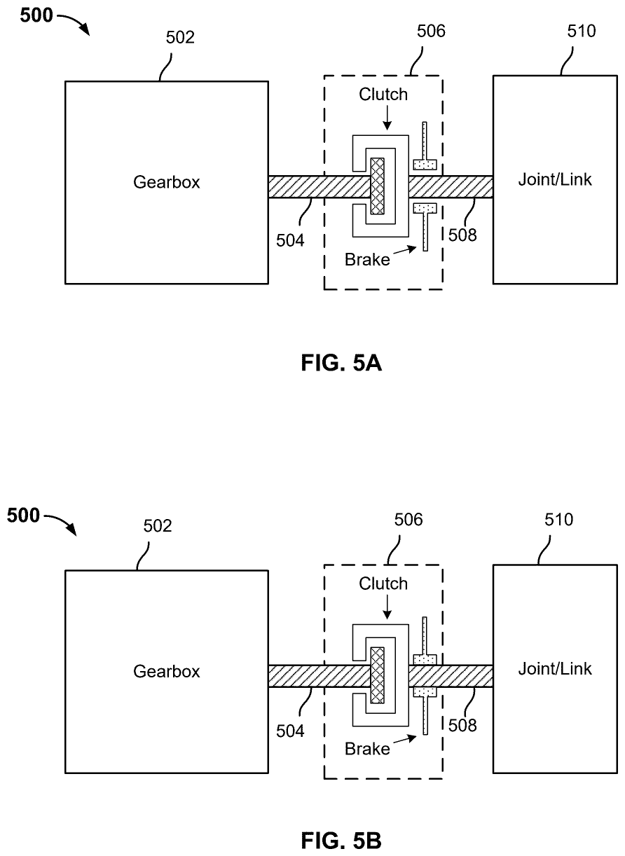

FIGS. 5A and 5B illustrate an example of a system incorporating such a brake. In the example shown, transmission assembly 500 includes a gearbox 502 having an output shaft 504 that is coupled to joint/link 510 via a clutch assembly 506 and shaft 508. As shown in FIG. 5A, both the clutch and associated brake included in clutch assembly 506 are disengaged, allowing the joint/link 510 initially to move freely, e.g., upon first detecting the overload condition. As shown in FIG. 5B, the brake included in clutch assembly 506 has been engaged, e.g., to gradually control movement of the joint/link 510, such as to ease it into the position shown in FIG. 1F without overshooting the vertical and/or with minimum oscillation about the vertical prior to stopping.

In some embodiments, a clutch and/or brake assembly, such as the one illustrated in FIGS. 5A and 5B, is incorporated integrally into a robotic control system and model for the robot. In addition to being used to prevent an item from being dropped or from colliding with the robotic arm or an obstacle in the workspace, the clutch and brake may be used to decouple the load from the gearbox and a determined time and/or in response to determined conditions other than and/or in addition to joint overload. In some cases, the brake may be applied using variable braking (e.g., friction) force over time, the braking force versus time profile being calculated to quickly but safely swing the link and load into a desired and sustainable pose. In some cases, the load may be too heavy to hold at an initial angle, but the system may determine it can be held securely at a shallower (e.g., wrist) angle that is not fully vertical, as in FIG. 1F.

In some embodiments, the clutch, brake, and robotic arm may be used to swing a load back and the forward, releasing the clutch and using the brake to time decoupling of the load from the wrist joint and gearbox at a moment timed to impart momentum to the load, which is then released by the end effector at a determined moment to hurl the item through a predetermined trajectory, e.g., to heave it over and behind a barrier or onto the top of a pile.

In various embodiments, a clutch and/or brake assembly may be used in various ways to facilitate the picking and placing of items. In some embodiments, machine learning techniques may be used to train a robotic system to use a clutch and/or brake assembly in a variety of ways to perform pick/place tasks.

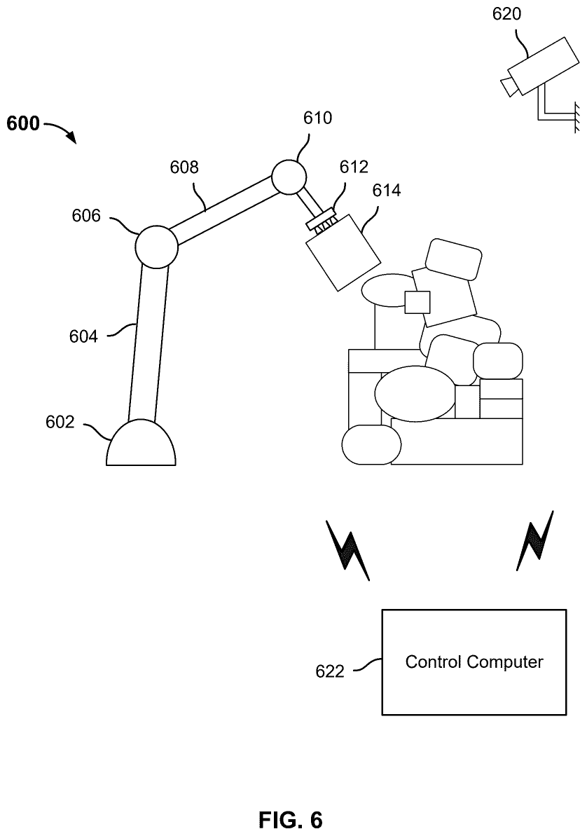

FIG. 6 illustrates a robotic system that adapts to robotic arm joint overload. In the example shown, robotic system 600 includes a robotic arm comprising shoulder joint 602, upper arm link 604, elbow joint 606, forearm link 608, wrist joint 610, and suction type end effector 612. In the example shown, the robotic arm has grasped item 614 with end effector 612 and just begun to pull item 614 from a pile of dissimilar arbitrary items.

Referring further to FIG. 6, in the example shown a camera 620 in the workspace provides image data to a control computer 622. In various embodiments, control computer 622 includes a computer vision module, e.g., software running in an environment on control computer 622, that uses image data provided by camera 620 and/or other sensors to construct and update a three-dimensional view of the workspace. For example, the computer vision module may be used to determine a plan to grasp and item, such as item 614, and to move the item through a planned trajectory to a destination, e.g., a box, pallet, conveyor, etc.

In various embodiments, the robotic arm includes one or more joints capable of handling an unexpected overload on the joint. For example, the joint may have a backdrivable gearbox or no gearbox. In various embodiments, a robotic system such as the system 600 of FIG. 6 may adapt to a detected overload condition. For example, computer vision may be used to detect that a grasped load has begun to move into a position associated with overload, such as by causing a joint to move in a direction other than expected, e.g., in a direction opposite of the torque being applied by the motor.

If, for example, the item 614 in FIG. 6 is observed to overload the wrist joint 610, as in the example illustrated in FIGS. 1A through 1F, in various embodiments the control computer 622 may take one or more actions to adapt to the observed condition. For example, the control computer 622 may do one or more of the following: discontinue applying and/or adaptively decreasing torque applied by the joint motor associated with the affected joint; make and implement a plan to gracefully ease the load into a torque neutral position with respect to the joint; take active measures to dampen oscillation of the item to either side of the torque neutral position; disengage a clutch mechanism to decouple the joint from its motor; and engage a brake to hold the item in a position, such as the torque neutral position or a position to which the item has been swung, via momentum, through manipulation of other joints comprising the robotic arm.

The adaptive behavior of the control computer 622 and/or other elements comprising the system 600 may include increase a frame rate of camera 620 and/or a sampling or other processing rate or parameter affecting who images provided by camera 620 are processed and/or used. Further adaptive behavior of the control computer 622 may include computing and implementing a new plan and trajectory to move the item through the workspace to the destination, without collisions, while maintaining the robotic arm in a pose that can be maintained despite the overload condition.

In some embodiments, a robotic arm comprising a system as disclosed herein may react, passively, actively, or both passively and actively, to an overload collision. For example, a robotic arm joint equipped with a backdrivable gearbox may reach passively, by being driven by the force/torque of the overload in a direction towards a force/torque neutral position. In another example, a control system configured to control a robotic arm controlled using position control may lower a control gain or other parameter, causing the system to try less hard to maintain or return to an intended position or pose.

In some embodiments, torque sensors in the joint and/or end effector may be used to detect an overload condition, and in response the system may reduce or remove the torque that was being applied to move or maintain the joint in the planned pose. In some embodiments, a system as disclosed herein may react to an overload condition in part by using a torque sensor reading to back predict the overload condition.

In various embodiments, machine learning may be used to learn to detect and respond to overload conditions. For example, different strategies may be used, within or across systems, to respond to a detected overload condition. The system(s) may learn over time to better respond to an overload condition, such as how to use a clutch to decouple the load from a joint motor or gearbox, whether and how to use a brake or motor torque to dampen oscillation, etc.

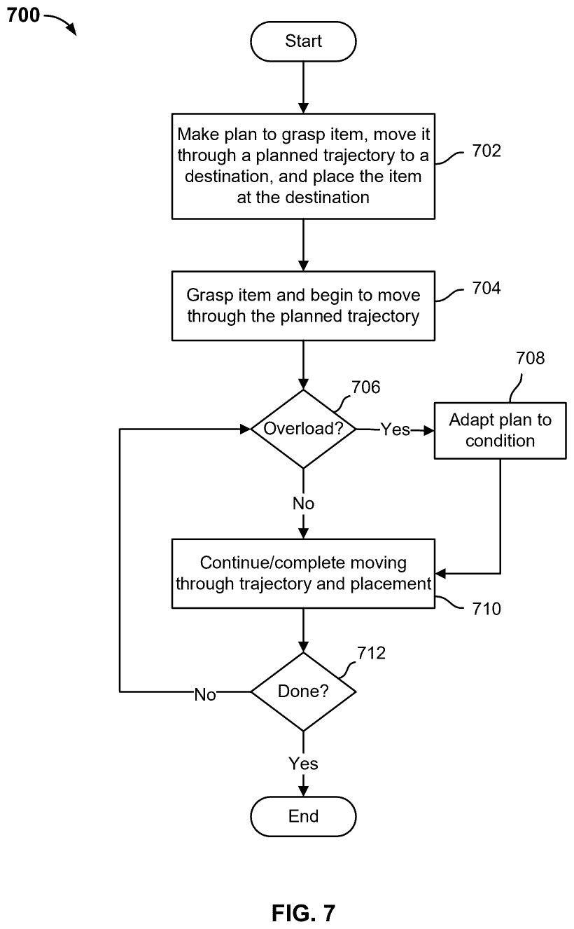

FIG. 7 is a flow diagram illustrating an embodiment of a process to adapt as or if necessary to robotic arm joint overload. In various embodiments, process 700 of FIG. 7 may be performed by a computer or other hardware processor, such as control computer 622 of FIG. 6. In the example shown, at 702, a plan is made to grasp item, move it through a planned trajectory to a destination, and place the item at the destination. At 704, the item is grasped and begins to be move through the planned trajectory. If an overload condition is detected, at 706, then at 708 the condition is adapted to, e.g., by adapting the plan to move the item to the destination.

Adapting the plan, at 708, may include one or more of the following: performing active measures to dampen oscillation or hold the item in a pose that can be sustained despite the overload and generating a new or modified plan and trajectory, e.g., to move the item through the workspace to the destination using only robot poses that can be sustained despite the overload. In some embodiments, the plan may be updated to place the item in a different position and/or orientation than originally planned. For example, if the original plan was to place the item while holding it in a side hold, i.e., the suction or other end effector gripping the item from the side, and the overload condition prevents the robot from holding the item in that manner, then the revised plan may include placing the item at the destination in a different orientation, e.g., on that allows the item to be dangled below the joint affected by the overload.

If no overload condition is detected, at 706, or once the planned has been updated to adapt to the overload condition (708), then at 710 the item continues to be moved according to the current plan. Processing continues until done (712), e.g., the item has been placed at the destination.

In various embodiments, techniques disclosed herein may be used to provide a robotic arm and system that adapts gracefully to overloads.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a robotic arm comprising one or more links, one or more joints, and an end effector positioned at a distal free moving end of the robotic arm; and
a processor configured to:
make and begin to implement a plan to grasp an item, move the item through a planned trajectory, and place the item at a destination;
detect an overload condition affecting a joint include in the one or more joints; and
adapt the plan in response to detecting the overload condition.

2. The robotic system of claim 1, wherein the joint comprises a wrist joint adjacent to the end effector.

3. The robotic system of claim 1, wherein detected overload condition is associated with an inability of the affected joint to hold the item in a planned pose.

4. The robotic system of claim 1, wherein overload condition is associated with an unexpected weight of the item.

5. The robotic system of claim 1, wherein adapting the plan includes allowing the item to move into a position that is torque neutral relative to the joint affected by the overload.

6. The robotic system of claim 1, wherein adapting the plan includes performing an active measure to dampen movement of the item into a position that is torque neutral relative to the joint affected by the overload.

7. The robotic system of claim 1, wherein the processor is further configured to take a responsive action in response to detecting the overload condition.

8. The robotic system of claim 7, wherein the responsive action includes on or more of the following: disengaging a clutch, engaging a brake, adjusting a control gain, and changing a torque applied at an affect joint.

9. The robotic system of claim 1, wherein adapting the plan includes causing the item to be held with the robotic arm in a pose such that the joint affected by the overload can maintain the pose.

10. The robotic system of claim 9, wherein adapting the plan includes swinging the item about an axis associated with the affected joint into a position that enables the robotic arm to be placed in the pose such that the joint affected by the overload can maintain the pose.

11. The robotic system of claim 1, wherein the affected joint is associated with a joint motor the output of which is coupled to the joint via a backdrivable gearbox.

12. The robotic system of claim 1, wherein the affected joint is associated with a joint motor the output of which drives a gearbox that is coupled to the joint via a clutch or other mechanism operable to selectively couple or decouple the joint to the output of the gearbox.

13. The robotic system of claim 12, further comprising a brake operable to hold the joint in a position.

14. The robotic system of claim 1, wherein the affected joint is driven by a direct drive joint motor.

15. The robotic system of claim 1, further comprising a camera configured to provide images to the processor and wherein the processor is configured to detect the overload condition based at least in part on the images.

16. The robotic system of claim 1, wherein adapting the plan includes determining to place the item in a different orientation than as originally planned.

17. The robotic system of claim 1, wherein adapting the plan includes planning a trajectory through which the robotic arm can safely move the item to the destination using only one or more poses that can be achieved and maintained despite the overload condition.

18. A method to control a robotic arm having one or more links, one or more joints, and an end effector positioned at a distal free moving end of the robotic arm, the method comprising:
making and beginning to implement a plan to grasp an item, move the item through a planned trajectory, and place the item at a destination;
detecting an overload condition affecting a joint include in the one or more joints; and
adapting the plan in response to detecting the overload condition.

19. The method of claim 18, wherein the affected joint comprises one or more of a joint coupled to joint motor via a backdrivable gearbox, a joint driven by a direct drive motor, and a joint selectively coupled to or decoupled from a gearbox via a clutch.

20. The method of claim 18, wherein adapting the plan includes allowing the item to move into a position that is torque neutral relative to the joint affected by the overload.

21. The method of claim 18, wherein adapting the plan includes performing an active measure to dampen movement of the item into a position that is torque neutral relative to the joint affected by the overload.

22. A computer program product to control a robotic arm having one or more links, one or more joints, and an end effector positioned at a distal free moving end of the robotic arm, the computer program product being embodied in a non-transitory computer readable medium and comprising computer instructions for:
making and beginning to implement a plan to grasp an item, move the item through a planned trajectory, and place the item at a destination;
detecting an overload condition affecting a joint include in the one or more joints; and
adapting the plan in response to detecting the overload condition.
